(19) United States
(12) Patent Application Publication
(10) Pub. No.: US 2025/0109285 A1
(43) Pub. Date: Apr. 3, 2025

(54) SYSTEMS AND METHODS FOR RECYCLING RUBBER WASTE INTO SURFACE-MODIFIED DEVULCANIZED RUBBER OR AN END-OF-LIFE TIRE (ELT) COMPOUND

(71) Applicant: 1307843 B.C. Ltd., Vancouver (CA)

(72) Inventors: Charles AL RACHID, Dubai (AE); Mohammad Akram HASHIM, Kuwait City (KW); Abbas JABBER, Beirut (LB); Abdallah Roger NASSIF, Baabda (LB)

(21) Appl. No.: 18/899,496

(22) Filed: Sep. 27, 2024

(30) Foreign Application Priority Data
Sep. 28, 2023 (CA) 3214767

(51) Int. Cl. C08L 17/00; B09B 3/35; B09B 3/38; B09B 3/40; B09B 3/50; B09B 101/80; B29B 13/08; B29B 17/04; C08J 11/12

(52) U.S. Cl. CPC C08L 17/00; B09B 3/35; B09B 3/38; B09B 3/40; B09B 3/50; B29B 13/08; B29B 17/0408; C08J 11/12; B09B 2101/80; C08J 2317/00; C08L 2205/03; C08L 2207/24; C08L 2207/322

(57) ABSTRACT

A system and a method for producing a surface devulcanized crumb rubber from vulcanized crumb rubber. The method comprising applying a dose of microwave energy to micronized vulcanized crumb rubber sufficient to sever sulfidic cross-links in the surface of the micronized vulcanized rubber crumb to produce a devulcanized crumb rubber. In aspects, the method relates to a method for producing an end-of-life tire compound from vulcanized crumb rubber comprising obtaining a surface devulcanized crumb rubber; mixing the surface devulcanized crumb rubber with a plastic polymer and/or an oil to form a devulcanized rubber mixture; and extruding the mixture through an extruder to produce the end-of-life tire compound.

### CROSS REFERENCE TO RELATED APPLICATION

This application claims priority to Canadian application No. 3214767 filed Sep. 28, 2023. The contents of which are hereby incorporated in their entirety by reference.

### TECHNICAL FIELD

Example embodiments relate to systems and methods for recycling rubber waste into surface-modified devulcanized rubber or an end-of-life tire (ELT) compound.

### BACKGROUND

An estimated greater than 40M tons or about 1 billion waste tires are discarded after their useful life globally each year. Only an estimated 16.2 M tons are recycled, whereas greater than 4.5 M tons are buried and about 19.8 M tons are burned. This means that 10-15% of waste tires takes up space in landfills and it will take over 50-80 years for these buried tires decompose and while in the landfill, are prone to catching fire. Burning each ton of waste tires emits 10 tons of CO₂ and causes air, water, and soil pollution. The low percentage of waste tire recycling is primarily because vulcanized rubber is extremely difficult to recycle and/or various current methods may not be efficient and/or cost effective.

Various current methodologies to recycle waste tires include using tires as TDFs where waste tires are shredded and used a fuel. It was though that TDF offers a viable alternative to the use of fossil fuels, as long as proper regulatory controls are in place. Depending on the type of combustion system, tires can be burned whole or in shredded form. Oftentimes tires must be reduced in size to fit combustion units, in addition to other preliminary processing. The environmental controversy surrounding use of this fuel is wide and varied. However, the greatest supported evidence of toxicity comes from the presence of dioxins and furans in the flue gases. Zinc has also been found to dissolve into storm water, from shredded rubber, at acutely toxic levels for aquatic life and plants. Research shows that huge polyaromatic emissions are generated from combustion of tire rubber, at a minimum, 2 orders of magnitude higher than coal alone. Therefore, since TDF results in release toxic chemicals and/or carcinogens, and CO₂ and other undesirable contaminants, it is unsuitable recycling method for waste tires.

Other known various methods to recycle waste tires include generation of crumb rubber which are rubber granules that are produced by reducing waste tires into granules after the removal of steel and fiber. However, the quality of the crumb rubber is relatively low and therefore there are limits to the types of products that this type of recycled rubber can be used for. Moreover, the recycled products of waste tires created by current various methodologies used to cover playgrounds and sports fields have been shown by recent research to contain elements (e.g. lead and manganese) that may cause cancer.

In other known various methods to recycle waste tires, these known methods require the use of harsh solvents and include one or more of toluene, naphtha, terpenes, benzene, cyclohexane, diethyl carbonate, ethyl acetate, ethylbenzene, isophorone, isopropyl acetate, methyl ethyl ketone, derivatives thereof and the like.

In other known various methods to recycle waste tires, these known methods require the use of chemical compatibilizers that can detrimentally affect the mechanical properties of the recycled rubber product.

In the vulcanization process, rubber polymer is cross-linked with sulfur, usually with the application of heat. Unfortunately, cross-linked rubber polymer cannot be reclaimed into a useful product merely by heating and re-processing. Sulfidic cross-linking represents a significant problem in recycling of rubber vulcanizate and in the recovery of the starting material rubber polymer from vulcanized rubber.

There is a need to provide systems and methods for recycling rubber waste that overcome the deficiencies in known methods.

### SUMMARY OF THE INVENTION

Example embodiments include systems and methods for recycling rubber waste. Example embodiments include systems and methods for producing a devulcanized crumb rubber from waste tires and/or an end-of-life tire compound that is a copolymer of rubber and plastic.

In one example embodiment, the systems and methods are used in producing a devulcanized crumb rubber from waste tires and/or an end-of-life tire compound that has a lower degree of cross-links and consequently provides for a more efficient method and realized increased industrial scalability and lower energy consumption.

In one example embodiment, the systems and methods are used in producing a devulcanized crumb rubber from waste tires and/or an end-of-life tire compound that can serve as a substitute for natural rubber.

In one example embodiment, the systems and methods are carried out in the absence of harsh chemicals and solvents and provides for a safe and environmentally sustainable process.

In one example embodiment, the systems and methods are carried out in the absence of chemical compatibilizers.

In one example embodiment, the systems and methods provide a significant advantage by the consumption of a significantly lower amount of energy to achieve better results especially when the devulcanized rubber is going to be used in TPV, TPE, and new tire formulations.

In one example embodiment, there is provided a method for producing a surface devulcanized crumb rubber from waste tires, the method comprising:
crumbling waste tires to produce a vulcanized crumb rubber;
micronizing the vulcanized crumb rubber to produce a micronized crumb rubber; and
applying a dose of microwave energy to the micronized crumb rubber of a frequency and a power sufficient to sever sulfidic cross-links in the surface of the micronized crumb rubber to produce the surface devulcanized crumb rubber.

In one example embodiment, there is provided a method for producing an end-of-life tire compound, the method comprising:
obtaining a surface devulcanized crumb rubber;
mixing the surface devulcanized crumb rubber with a plastic polymer and/or an oil to form a devulcanized rubber mixture; and
extruding the mixture through an extruder to produce the end-of-life tire compound.

In one example embodiment, there is provided a method for producing an end-of-life tire compound from vulcanized crumb rubber comprising applying a dose of microwave energy to the vulcanized crumb rubber sufficient to sever sulfidic cross-links in the vulcanized rubber crumb to produce a devulcanized crumb rubber; mixing the devulcanized crumb rubber with a plastic polymer and/or an oil to form a devulcanized rubber mixture; and extruding the mixture through an extruder to produce the end-of-life tire compound.

In example aspects, the crumbling is by mechanical shredding of the waste tires sufficient to obtain the devulcanized crumb rubber

In example aspects, the method further comprises separating the vulcanized crumb rubber from metal and/or fibrous material of the waste tires.

In example aspects, prior to the application of the dose of microwave energy, the method further comprises micronizing the vulcanized crumb rubber. In aspects, the micronizing comprises cryogenic freezing of the waste tires and comminuting the cryogenically frozen waste tires by an impact sufficient to obtain the micronized devulcanized crumb rubber.

In example aspects, the extruding is by twin-screw extrusion.

In example aspects, the plastic polymer is recycled plastic polymer waste and the oil is engine oil. In example aspects, the devulcanized rubber mixture comprises a ratio of the devulcanized crumb rubber to the plastic polymer about 1:2

In example aspects, the method produces the end-of-life tire compound in the absence of chemical, solvents, and/or compatibilizers.

In example aspects, the microwave energy is of a frequency of between 915 MHz and 2450 MHz and between 41 and 177 watt-hours per pound.

In example aspects, the microwave energy is of a frequency and a power only necessary to sever sulfidic cross-links in the surface of the vulcanized rubber crumb to produce a devulcanized crumb rubber.

In one example embodiment, there is provided a system for producing an end-of-life tire compound from vulcanized crumb rubber, the system comprising:
a microwave for applying a dose of microwave energy to the vulcanized crumb rubber sufficient to sever sulfidic cross-links in the vulcanized rubber crumb to produce a devulcanized crumb rubber;
a mixer for mixing the devulcanized crumb rubber with a plastic polymer and/or an oil to form a devulcanized rubber mixture; and
an extruder for extruding the mixture through an extruder to produce the end-of-life tire compound.

In example aspects, the extruder is a twin-screw extruder and/or the plastic polymer is recycled plastic polymer waste and the oil is engine oil.

In example aspects, the microwave is configured to apply a dose of microwave energy to the vulcanized crumb rubber sufficient to sever the sulfidic cross-links only in the surface of the vulcanized rubber crumb.

### BRIEF DESCRIPTION OF THE DRAWINGS

FIG. 1 is a flowchart of a method for producing an end-of-life tire compound in accordance with an example embodiment;

FIG. 2 is a schematic of a system for producing an end-of-life tire compound and TPE masterbatches in accordance with an example embodiment;

FIG. 3 is a schematic showing the chemical process by which sulfidic cross-links in the vulcanized crumb rubber are severed to produce the devulcanized crumb rubber;

FIG. 4 shows available product suites using the end-of-life tire compound in accordance with an example embodiment;

FIGS. 5A, 5B, 5C and 5D show available use in automotive parts using the end-of-life tire compound in accordance with an example embodiment; and

FIG. 6 is a flowchart of a method for producing a devlucanized crumb rubber in accordance with an example embodiment.

### DETAILED DESCRIPTION

Reference will be made below in detail to exemplary embodiments, examples of which are illustrated in the accompanying drawings. Wherever possible, the same reference numerals used throughout the drawings refer to the same or like parts.

The term “ELT compound” means end-of-life tire compound.

The term “TPVs” means thermoplastic elastomers, which are a part of the TPE family of polymers.

The term “TPE” means thermoplastic elastomers/thermoplastic rubbers.

The term TDF” means tire-derived fuel.

A particularly suitable application of the rubber devulcanization process in accordance with an example embodiment is the recovery of a useable rubber polymer from discarded waste tires and tire factory waste material.

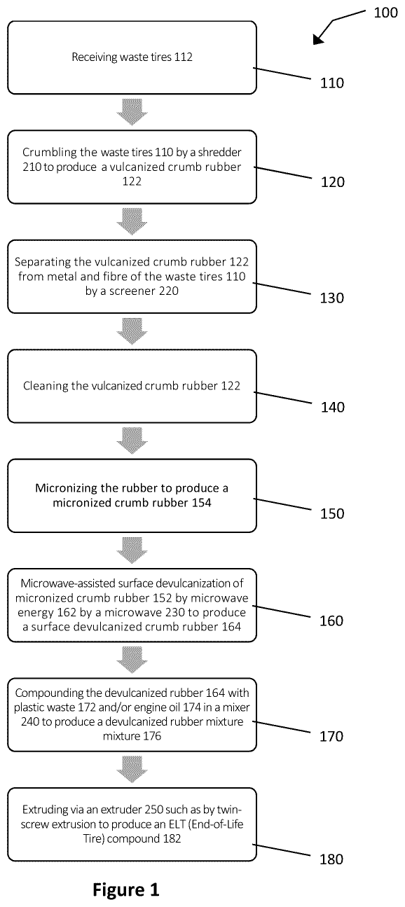

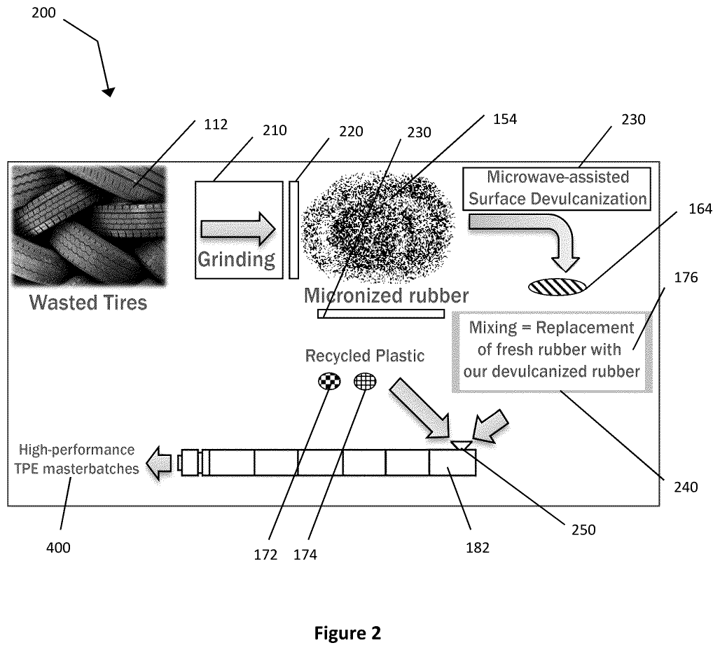

As shown in FIG. 1, according to an embodiment, in a method 100 in accordance with an example embodiment to produce an end-of-life tire compound 172 and as shown in FIG. 2 in accordance with an example embodiment is a system 200 to produce the end-of-life tire compound 172 and TPE masterbataches. In the method of 100 at step 110 discarded waste tires and/or tire factory waste material 112 are obtained and at step 120 the discarded waste tires 112 are reduced to a suitable size by shredding, chopping or cutting, in a manner known to those skilled in the art, to produce the vulcanized crumb rubber 122.

As shown in FIG. 2, for example, the reduction in size is achieved by mechanical methods using a shredder 210 to shred/grind the rubber to reduce the sizer of the rubber into smaller pieces, where the size of the pieces can be then regulated using a granulator, or a similar device.

At a screening stage 130, all steel and other fibers that affect the usability are removed. Steel and/or fibre can be separated from the vulcanized crumb rubber 122 in a manner known to those skilled in the art to separate any steel and/or fibre. For example, in a screener 220, the steel pieces can be removed with a strong magnet and other materials can be removed with an air classifier, or a similar device. During the screening stage 130 the vulcanized crumb rubber 122 can also sorted by the size of the particle and any pieces that are too big are removed.

At a cleaning stage 140, the screened vulcanized crumb rubber 122 is cleaned using water or other cleaning substances.

At a micronizing stage 150, the reduction in size is by a micronizer 230 using cryogenic methods where the rubber is frozen with liquid nitrogen. The frozen rubber is then smashed to smaller pieces with a hammer mill to produce a micronized crumb rubber 154.

At a microwave-assisted surface devulcanization stage 160, the micronized crumb rubber 152 is subjected to one or more doses of microwave energy 162 by a microwave 230 to produce a devulcanized crumb rubber 164.

Without being limited to any particular theory, the process takes advantage of volumetric heating of the material by microwaves, promoting a more uniform heating than that achieved by traditional heating methods. The process has physical nature, i.e., it does not involve chemicals during the process. In some example, it is a type of thermal devulcanization or controlled degradation, allowing the application of high amount of energy to the material in a short time, resulting in high productivity, being considered as an eco-friendly technology.

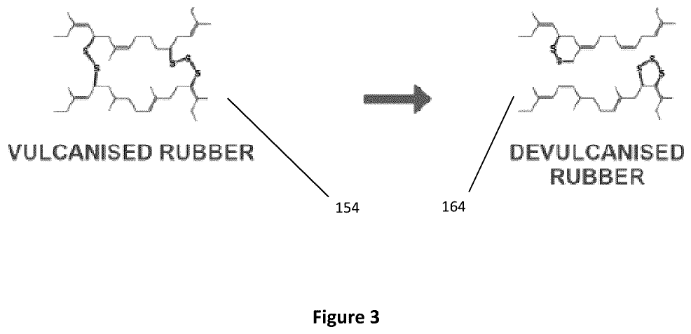

Microwave-treated devulcanized rubber has desirable properties, and the method has high productivity. In particular, microwave devulcanization takes advantage of volumetric heating: a fast and uniform rise in temperature can be achieved and the selective scission of sulfuric cross-links is possible with control and selection of parameters (temperature, exposure time, microwave power) sufficient to sever sulfidic cross-links (e.g. monosulfidic, disulfidic, and polysulfidic cross-links) in micronized crumb rubber 154 to produce devulcanized rubber 164 as shown in FIG. 3.

In some examples, the applied microwave energy 162 is in a dose having a frequency and watt-hours per weight of the vulcanized crumb rubber sufficient to sever sulfidic cross-links only in the surface of the micronized crumb rubber 154 to produce surface devulcanized crumb rubber 164. In some example embodiments, the micronized crumb rubber 154 subjected to one or more doses of microwave energy 162 of between 915 MHz and 2450 MHz and/or between 41 and 177 watt-hours per pound of the micronized crumb rubber 154 to sever sulfidic cross-links in the micronized crumb rubber 154 to produce the devulcanized crumb rubber 164.

In some examples, the microwave energy 162 is used at a much lower extent to devulcanize only the surface of micronized rubbers 154 and/or the vulcanized crumb rubber 122.

At a compounding stage 170, in one embodiment, the produced devulcanized crumb rubber 164 from the microwave-assisted surface devulcanization can be advantageously mixed in a mixer 240 with a plastic polymer 172 and/or an oil 174 to form a devulcanized rubber mixture 176 in the mixer 240.

At an extrusion stage 180, in one embodiment, the devulcanized rubber mixture 176 is passed through an extruder 250 to produce the end-of-life tire compound 182, and in some example embodiments, the extruder 250 is via a twin-screw extruder and twin-screw extrusion process.

The attained physical and mechanical results in lab-scale showed a significant improvement regarding the previous approaches for producing the ELT compound 182.

As discussed above, in some example embodiments, the method is not a thermomechanical or any other chemical approach. In some examples, a cryogenic approach is employed to grind the rubber parts of the wasted tires to achieve micrometer-scaled granulates. In example embodiments, the method improves the efficiency of compounding the devulcanized tire waste with plastic waste through surface modification of the devulcanized rubber and this eliminates the need to use high contents of compatibilizer so the physical/mechanical properties of the devulcanized rubber are well improved to enable formulations that have a higher load.

In one example embodiment, the method can produce the end-of-life tire compound 182 from the vulcanized crumb rubber 122 in the absence of harsh solvents that include one or more of toluene, naphtha, terpenes, benzene, cyclohexane, diethyl carbonate, ethyl acetate, ethylbenzene, isophorone, isopropyl acetate, methyl ethyl ketone, derivatives thereof and the like.

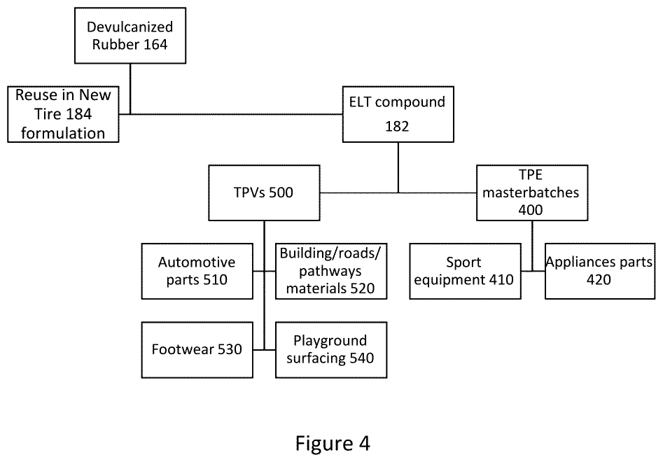

As shown in FIG. 4, the devulcanized rubber 164 has many other applications including use in formation of new tires 184. Moreover, as shown in FIG. 4, the devulcanized rubber 164 and the ELT compound 182 can be used in the formation of thermo plastic elastomers (TPE) masterbatches 400 and thermo plastic vulcanizates (TPV) 500. Beneficially, the produced surface-modified surface devulcanized rubbers can be then incorporated into TPE/TPV formulations which combine the advantages of rubbers to those of plastic materials and offer a wide panel of properties.

Exemplary uses of TPE 400 includes sports equipment parts 410, and appliance parts 420 and exemplary uses of TPV 500 includes automotive parts 510, road materials 520, footwear 530, and playground surfacing materials 540. Therefore, depending on the required final product, it is possible to adjust the TPE/TPV formulation to achieve one or more of the following: simplified processing where it can be further processed by extrusion, injection, molding, or blow molding; and ease of use scraps and waste recycling.

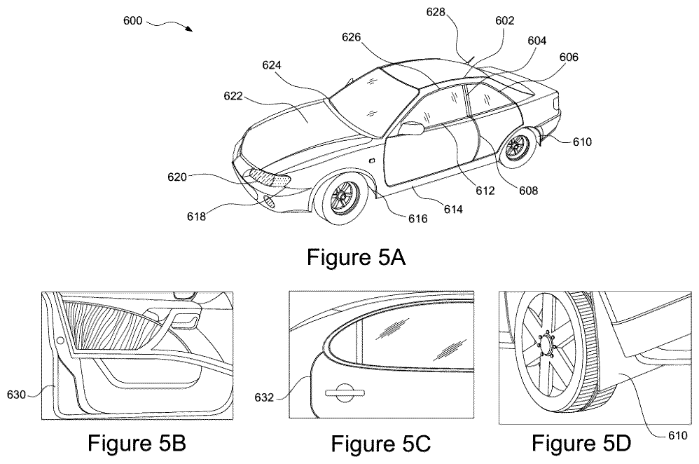

As shown in FIGS. 5a, 5b, 5c, and 5d, automotive parts 510 for use in a vehicle 600 can be formed by using the recycling method of the present invention to produce the devulcanized rubber 164. Some example usable automotive parts 510 are shown in FIG. 5a include, but are not limited to: roof molding 602, B pillar seal 604, QW seals 606, door cushion rubber 608, mud guard 610, belt molding (inner and outer) 612, side molding 614, fender liner 616, seal fender apron 618, headlight seal breathing gap 620, air intake hose 622, cowl louvre protector 624, glass run channel 626, and roof antenna cover 628. Some example useable automotive parts 510 are shown in FIGS. 5b, 5c, and 5 are door trim skin 630, weather seals 632, and the mud guard 610, respectively.

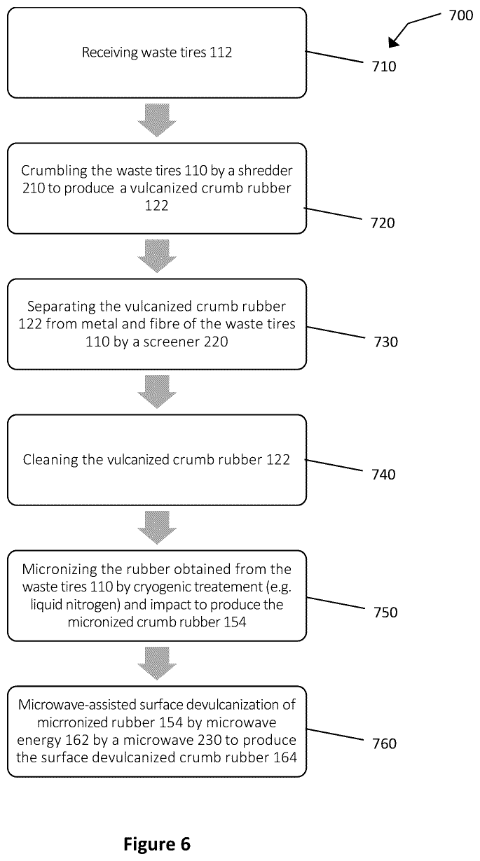

As shown in FIG. 6, according to an embodiment, in a method 700 in accordance with an example embodiment to produce the devulcanized crumb rubber 154. In the method of 700 at step 710 discarded waste tires and/or tire factory waste material 112 are obtained and at step 720 the discarded waste tires 112 are reduced to a suitable size by shredding, chopping or cutting to produce the vulcanized crumb rubber 122.

At a screening stage 730, all steel and other fibers that affect the usability are removed. Steel and/or fibre can be separated from the vulcanized crumb rubber 122.

At a cleaning stage 740, the screened vulcanized crumb rubber 122 is cleaned using water or other cleaning substances.

At a micronizing stage 750, a reduction in size is achieved by cryogenic treatment where the rubber is frozen with liquid nitrogen. The frozen tires are then smashed to smaller pieces by physical impact, such as by a hammer mill (not shown) to produce the micronized crumb rubber 154.

At a microwave-assisted surface devulcanization stage 760, the micronized crumb rubber 154 is subjected to one or more doses of microwave energy 162 by the microwave 230 to produce the surface devulcanized crumb rubber 164.

The devulcanization process as depicted in steps 160 and 760 recover materials like the virgin product by scission of the polysulfide bonds induced during the vulcanization process. Devulcanization/reclaiming of scrap rubber is the most advantageous technique to solve the disposal problem. Devulcanization is the process of cleaving the monosulfidic, disulfidic, and polysulfidic crosslinks of vulcanized rubber.

The employed approach is eco-friendly since it relates to a specific microwave mechanism for the devulcanization process which is performed in the absence of chemical agents.

The method is more environmentally friendly than most existing techniques due to the usage of microwave energy instead of chemical reagents by known thermomechanical or any other chemical approach.

The method produces devulcanized material having desirable properties and the possibility of high productivity. The method takes advantage of volumetric heating of the material by microwaves, promoting a fast and uniform rise in temperature (heating) than that achieved by traditional heating methods.

The selective scission of sulfuric cross-links is possible with the selection of the suitable parameters (temperature, exposure time, microwave power) as disclosed.

In some aspects, the process has physical nature, i.e., it does not involve chemicals during the process. Moreover, the uniformity of the devulcanization is one major parameter controlling the properties of the recycled rubber.

In some aspects, the employed microwave-based mechanism gives a high level of uniformity in terms of eliminating cross-links in comparison to other commercialized devulcanization methods.

In one aspect, it is a type of thermal devulcanization or controlled degradation, allowing the application of high amount of energy to the material in a short time, resulting in high productivity, being considered as an eco-friendly technology.

In one aspect, the microwave energy is used at a much lower extent to only devulcanize the surface of micronized rubbers. One advantage is the consumption of a significantly lower amount of energy to achieve better results especially when the devulcanized rubber is going to be used in TPV, TPE, and new tire formulations. The attained physical and mechanical results in lab-scale showed a significant improvement regarding the previous approaches.

Based on the preliminary evaluation in lab-scale, the amount of energy consumption was reduced to 40-60% of the energy consumed by other common microwave methods reported so far due to the surface devulcanization approach.

In some embodiments, after the surface devulcanization is complete, the present invention relates to further steps including the compounding step 170 and the extruding step 180 that introduce a specific surface modification to the devulcanized rubber to make it more functional especially for TPV, TPE, and new tire formulations.

In this way, the final product can be is more readily incorporated into a wide range of formulations including new tire as well as TPE/TPV products.

In one aspect, there will be no need to use chemical compatibilizers leading to higher mechanical properties and a more cost-effective formulation.

The produced surface-modified devulcanized rubbers can be added-value products when incorporated into TPE/TPV formulations. They combine the advantages of rubbers to those of plastic materials and offer a wide panel of properties. Therefore, depending on the required final product, it is possible to adjust the TPE/TPV formulation to address any specific requirements.

Therefore, the present methods result in one or more of simplified processing; flexibility by processed by extrusion, injection molding or blow molding; and ease of use of scraps and waste recycling.

Therefore, the present methods also improve the efficiency of compounding the devulcanized tire waste with plastic waste through surface modification of the devulcanized rubber and eliminates the need to use any compatibilizers, which are expensive and can detrimentally affect the physical and chemical properties of the product.

Once compounded with plastics, the produced thermoplastic elastomers (TPEs) is endless. In examples, they range from the fabrication of automotive parts to playground mats as discussed above and shown in FIG. 4.

The use of recycled waste tire as a filler in the production of new tires has been a challenging issue since a limited content can be added to the formulation. Since the devulcanized rubber is surface modified, it could be added at a higher inclusion leading to a higher efficiency of recycling. In fact, the increased compatibility allows for the addition of a higher content of recycled rubber into the new tire formulation. The surface modification approach is one of the advantages of this technology compared with other recycled rubber production lines. This advantage could be considered as an incentive for both tire and TPE manufacturers incorporate the recycled rubber due to the higher load of rubber in tires and TPE formulations along with no need for the use of compatibilizers. Additionally, it has been demonstrated that the final product performs better both physically and mechanically due to the absence of compatibilizers.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are provided for illustrative purposes only and are not intended to be limiting on the scope of the invention. The subject matter described herein and in the recited claims intends to cover and embrace all suitable changes in technology.

1. A method for producing a surface devulcanized crumb rubber from waste tires, the method comprising:
crumbling waste tires to produce a vulcanized crumb rubber;
micronizing the vulcanized crumb rubber to produce a micronized crumb rubber; and
applying a dose of microwave energy to the micronized crumb rubber of a frequency and a power sufficient to sever sulfidic cross-links in the surface of the micronized crumb rubber to produce the surface devulcanized crumb rubber.

2. The method of claim 1 wherein the crumbling is by mechanical shredding of the waste tires sufficient to obtain the devulcanized crumb rubber and the micronizing is by cryogenically freezing and then comminuting to produce the micronized crumb rubber.

3. The method of claim 2 wherein the cryogenically freezing is by liquid nitrogen and the comminuting is by an impact sufficient to obtain the micronized crumb rubber.

4. The method of claim 2 wherein the comminuting produces micrometer-sized vulcanized crumb rubber.

5. The method of claim 1 further comprising separating the vulcanized crumb rubber from metal and/or fibrous material of the waste tires.

6. The method of claim 5 further comprising sorting the separated vulcanized crumb rubber by size and retaining sized vulcanized crumb rubber suitable for the micronizing.

7. The method of claim 1 wherein prior to the applying of the dose of microwave energy, the method further comprising cleaning the vulcanized crumb rubber.

8. The method of claim 7 wherein the cleaning comprises exposing the vulcanized crumb rubber to one or more of water and cleaning substances.

9. The method of claim 1 wherein the microwave energy is of a frequency of between 915 MHz and 2450 MHz and between 41 and 177 watt-hours per pound.

10. A devulcanized crumb rubber produced according to the method of any one of claim 1.

11. A method for producing an end-of-life tire compound, the method comprising:
obtaining a devulcanized crumb rubber produced according to the method of claim 1;
mixing the devulcanized crumb rubber with a plastic polymer and/or an oil to form a devulcanized rubber mixture; and
extruding the mixture through an extruder to produce the end-of-life tire compound.

12. The method of claim 11 wherein the extruding is by twin-screw extrusion.

13. The method of claim 11 wherein the plastic polymer is recycled plastic polymer waste and the oil is engine oil.

14. The method of claim 11 wherein the method produces the end-of-life tire compound in the absence of chemicals and/or compatibilizers.

15. The method of claim 11 wherein the devulcanized rubber mixture comprises a ratio of the devulcanized crumb rubber to the plastic polymer about 1:2.

16. An end-of-life tire compound produced according to the method of claim 11.

17. A system for producing an end-of-life tire compound from vulcanized crumb rubber, the system comprising:
a microwave for applying a dose of microwave energy to the vulcanized crumb rubber sufficient to sever sulfidic cross-links in the vulcanized rubber crumb to produce a devulcanized crumb rubber;
a mixer for mixing the devulcanized crumb rubber with a plastic polymer and/or an oil to form a devulcanized rubber mixture; and
an extruder for extruding the mixture through an extruder to produce the end-of-life tire compound.

18. The system of claim 17 wherein the extruder is a twin-screw extruder and/or the plastic polymer is recycled plastic polymer waste and the oil is engine oil.

19. The system of claim 17 further comprising a micronizer for comminuting the vulcanized crumb rubber to micrometer-sizes suitable for application to application of the dose of microwave energy.

20. The system of claim 17 wherein the microwave is configured to apply a dose of microwave energy to the vulcanized crumb rubber sufficient to sever only the sulfidic cross-links in the surface of the vulcanized rubber crumb.
